(19) United States
(12) Patent Application Publication
(10) Pub. No.: US 2007/0083938 A1
(43) Pub. Date: Apr. 12, 2007

(54) Invalidity monitoring program, invalidity monitoring method and invalidity monitoring system

(76) Inventors: Osamu Aoki, Suginami-ku (JP); Masaharu Shirasugi, Koto-ku (JP); Kenichi Koide, Edogawa-ku (JP); Hiroaki Kawano, Chiba-shi (JP)

Correspondence Address: SCHIFF HARDIN, LLP;PATENT DEPARTMENT, 6600 SEARS TOWER, CHICAGO, IL, 60606-6473, US

(21) Appl. No.: 10/579,668

(22) PCT Filed: Jul. 9, 2004
(86) PCT No.: PCT/JP04/09860

§ 371 Date: May 17, 2006

(30) Foreign Application Priority Data
Nov. 17, 2003 (JP) 2003-387212

(51) Int. Cl. G06F 17/30

(52) U.S. Cl. 726/30

(57) ABSTRACT

For monitoring invalid data that causes a computer to execute an invalid operation, an invalidity-monitoring program monitors input/output data sent to and received from a network and an externally connected device, and allows a user to set a variety of invalidity determination and apply an efficient rule. A data-acquisition unit acquires input/output data, which is flowing on a network or an externally connected bus, and the ID of an operator. An invalid-operation-determination unit determines whether an operation is invalid by acquiring attribute information on a user corresponding to the ID from a user-storage unit by referencing a rule corresponding to attribute information from rules stored in an invalidity-rule-storage unit and defined for the respective user, and additionally, by referencing a rule that generally determines an operation as invalid regardless of the attributes stored in the invalidity-rule storage unit. If the operation is invalid, an interruption-processing-execution unit stops the operation processing.

### BACKGROUND

The invention relates to an invalidity-monitoring program, invalidity-monitoring method and invalidity-monitoring system for monitoring invalid data that causes a computer to execute an invalid operation.

When a computer is connected to a network such as the Internet and used, it is necessary to prevent the input of invalid data from the outside, as well as prevent the flow of data or the leaking of data from the inside due to invalid operation of the computer. In order to prevent the input of invalid data, placing a firewall between internal networks such as an in-office LAN and blocking invalid data, or using anti-virus software in an internal network or individual computer terminal to prevent viruses is widely performed. In firewalls or anti-virus software, it is common for rules for determining invalid data from keywords, the IP address of the sender, or the like to be set in advance, and then determine whether or not data is invalid data by referencing those rules.

On the other hand, as a method for preventing the flow of data due to invalid operation, Japanese Patent Application No. 2002-232451 (“the '451 Application”) discloses technology in which rules for data being sent to the network, such as the right of access, sender, type of document sent, or the like are referenced, and when a possibility of invalidity is detected, transmission is interrupted.

The aforementioned firewall, anti-virus software and invention disclosed the '451 Application are each methods for preventing invalid access to or leaking of data from a network. However, invalid operation using a computer is not limited to methods via a network; for example, there is also a danger of the flow of information by methods not using a network such as invalid operation of a computer that is not connected to an external network by an unauthorized third party and outputting information stored on a computer to a printer or writing information to an external disc. In other words, it is preferred that monitoring of data that executes an invalid operation be performed not only between a computer and network, but also on the driver level of computers connected to a printer or drive.

Also, as was explained above, current methods for monitoring invalid data are mainly based on stored rules such as keywords, IP addresses, MAC addresses, and the like, however, depending on the method used, there are limits on the contents of rules that can be stored. In order to perform a determination accurately, it is preferable that the number of rules be increased as much as possible; however, when there are too many rules, a problem exists in that the processing required for determination becomes heavy. Therefore, it is effective to simplify rules from a variety of aspects as much as possible and store them, and to employ a system so that those rules are referenced efficiently.

Furthermore, a level-based invalidity determination has problems in that by performing a level-based determination alone using methods completely different than conventional methods, it is difficult to detect when an invalid operation that is not in accordance to the stored rules is being executed. Therefore, it is effective to be able to accurately determine whether or not there is a possibility of invalidity by understanding the operating patterns of new users.

### SUMMARY

Taking into consideration the problems mentioned above, the object of the present invention is to provide an invalidity-monitoring program, invalidity-monitoring method and invalidity-monitoring system capable of monitoring data that is input or output between not only a computer and a network, but also between a computer and external devices when monitoring invalid data that executes an invalid operation of a computer, and which allows the user to set and effectively apply various rules for determining invalidity.

A first aspect of the invention for solving the aforementioned problems is an invalidity-monitoring program for monitoring invalid data, which causes a computer to execute an invalid operation, and causes the computer to execute: a step of acquiring input/output data that is input or output over a network that is connected to the computer, or over an externally connected bus that connects the computer with an external device; a step of identifying ID information from the input/output data for identifying a user; a step of acquiring at least part of the attribute data corresponding to the ID information from a user-information-storage unit that stores attribute information for all users having authorization to use the computer; a step of referencing a determination-rule-storage unit that stores rules for determining whether the input/output data is invalid data, and determining whether the input/output data is invalid data; and a step of stopping execution by the input/output data when it is determined in the invalid-data-determination step that the input/output data is invalid data; and where the determination-rule-storage unit stores determination rules that correspond to user attributes; and in the step of determining whether the input/output data is invalid data, references the determination rules that correspond to attribute information acquired in the step of acquiring attribute information to determine whether the input/output data is invalid.

In this first aspect of the invention, by monitoring data that is input or output over not only a network, but also an externally connected bus of the computer, it is possible to monitor data that gives instructions not over a network for performing an operation such as an invalid printout or writing to a disc, and to interrupt that invalid operation. Also, by adding determination items corresponding to user attribute information, it is possible to diversify the rules.

In this first aspect of the invention, the computer can be used as a client, or can be used as a server over the network, as long as the computer is connected to a network and provided with an externally connected bus. This network includes all networks that are capable of sending or receiving data such as an LAN, dial-up network or the like. The external device includes all peripheral devices that can be connected to a computer via an externally connected bus such as a printer, drive or the like. Invalid data is data related to invalid operation of the computer, such as an instruction to send a file to the outside that is prohibited to be sent, operation by an unauthorized user, etc. A user's age, sex, department, position, or the like can be used as user attribute information.

This first aspect of the invention can also cause the computer to execute: a step of referencing the user-information-storage unit and determining whether the user corresponding to the ID information has authorization to use the computer; and a step of stopping operation by the input/output data when it is determined in the step of determining authorization that there is no authorization to use the computer; and where the step of determining authorization is executed before the step of determining whether the input/output data is invalid data; and when it is determined in the step of determining authorization that there is no authorization to use the computer, causes the computer to not execute at least one of the following, the step of acquiring attribute information or the step of determining whether the input/output data is invalid data.

In this first aspect of the invention, user attributes are registered in advance so that they can be used as rule items, so it is possible to easily check whether or not a user performing an operation is authorized to use the computer. By determining whether a user is authorized to use the computer before rule determination, it is possible to improve efficiency of applying rules by performing a process to stop the operation before applying rules when it is determined in the first stage that the operation is by a user that is not authorized to use the computer.

Furthermore, this first aspect of the invention can also cause the computer to execute a step of referencing a profile-storage unit that stores log data related to the input/output data as profiles for each user, and comparing the input/output data that was acquired in the data-acquisition step with the normal operation trend of the user to determine whether operation is unusual; and stops the operation executed by the input/output data in the step of stopping operation executed by the input/output data also when it is determined in the step of determining whether operation is unusual that operation is unusual.

By collecting log data for each user in this way, a profile containing the characteristics of the operation of each user is created, and by referencing the profile in question and determining whether or not the user is performing unusual operation, it is possible to determine when there is a possibility that a third party is posing as an authorized user, which could not be determined by rules, and to determine operation, which even though it is in the range of being authorized, could be invalid operation that is not normally executed.

Moreover, this first aspect of the invention can also execute a process of interrupting a session in the step of stopping the operation executed by the input/output data when the input/output data is acquired from a network in the step of acquiring input/output data.

Furthermore, this first aspect of the invention can also stop the process of executing a driver in the step of stopping the operation executed by the input/output data when the input/output data is acquired from an externally connected bus in the step of acquiring input/output data.

In this first aspect of the invention, when it is determined that the process being executed by the computer is an invalid operation, processing is performed so that the execution of that operation is quickly stopped. When the process being executed is sending or receiving data over a network, it is possible to prevent leakage of information due to transmission of data to the outside by performing a process of interrupting the session being executed. When the process being executed is for operating an external device by way of an externally connected bus, it is possible to prevent leakage of information due to the output of data by stopping the process of executing the driver.

A second aspect of the invention is an invalidity-monitoring program for monitoring invalid data, which causes a computer to execute an invalid operation, and causes the computer to execute: a step of acquiring input/output data that is input or output over a network that is connected to the computer, or over an externally connected bus that connects the computer with an external device; a step of identifying ID information from the input/output data for identifying a user; a step of acquiring at least part of the attribute data corresponding to the ID information from a user-information-storage unit that stores attribute information for all users having authorization to use the computer; a step of referencing a determination-rule-storage unit that stores rules for determining whether the input/output data is invalid data, and determining whether the input/output data is invalid data; and a step of notifying the terminal being operated by the user or administrator that the operation being executed by the input/output data is an invalid operation when it is determined in the step of determining whether the input/output data is invalid that the input/output data is invalid data; and where the determination-rule-storage unit stores determination rules that correspond to user attributes; and in the step of determining whether the input/output data is invalid data, references the determination rules that correspond to attribute information acquired in the step of acquiring attribute information and determines whether said input/output data is invalid data.

Instead of stopping the process being executed by that data when it is determined that the input/output data is invalid data in the first aspect of the invention, in this second aspect of the invention, invalid data is handled by notifying the user that is executing a process with that data, or notifying the computer or terminal administrator.

The first and second aspects of the invention could also be specified as an invalidity-monitoring method that executes the aforementioned invalidity-monitoring program. Also, they can be constructed as an invalidity-monitoring system that uses the aforementioned invalidity-monitoring program.

In other words, the first aspect of the invention could also be constructed as an invalidity-monitoring system for monitoring invalid data, which causes a computer to execute an invalid operation, and comprising: a data-acquisition mechanism that acquires input/output data that is input or output over a network that is connected to the computer, or over an externally connected bus that connects the computer with an external device; an ID-information-identification mechanism that identifies ID information from the input/output data for identifying a user; a user-information-storer that stores attribute information for all users having authorization to use the computer; an attribute-information acquisition mechanism that acquires at least part of the attribute data corresponding to the ID information from the user-information-storer; a determination-rule-storer that stores rules for determining whether the input/output data is invalid data; an invalid-data-determination mechanism that references the determination-rule-storer, and determines whether the input/output data is invalid; and a stoppage mechanism that stops execution by the input/output data when is determined by the invalid-data-determination mechanism that the input/output data is invalid date; and where the determination-rule-storer stores determination rules that correspond to user attributes; and the invalid-data-determination mechanism references the determination rules that correspond to attribute information acquired by the attribute-information-acquisition mechanism to determine whether the input/output data is invalid.

The first aspect of the invention can also comprise a use-authorization-determination mechanism that references the user-information-storer and determines whether the user corresponding to the ID information has authorization to use the computer; and where the stoppage mechanism also stops operation executed by the input/output data when it is determined by the use-authorization-determination mechanism that there is no authorization to use the computer; the use-authorization-determination mechanism is activated before the invalid-data-determination mechanism; and when it is determined by the use-authorization-determination mechanism that there is no authorization to use the computer, at least one of following: the attribute-information-acquisition mechanism or the invalid-data-determination mechanism is not executed.

Also, the first aspect of the invention can comprise: a profile-storer that stores log data related to the input/output data as profiles for each user; and an unusual-operation-determination mechanism that references the profile-storer and compares input/output data that was acquired by the data-acquisition mechanism with the normal operation trend of the user to determine whether operation is unusual; and where the stoppage mechanism also stops the operation executed by the input/output data when it is determined by the unusual-operation-determination mechanism that operation is unusual.

Moreover, in the first aspect of the invention, the stoppage mechanism can execute a process of interrupting a session when the data-acquisition mechanism acquired input/output data from a network.

Furthermore, in the first aspect of the invention, the stoppage mechanism can stop the process of executing a driver when the data-acquisition mechanism acquired input/output data from an externally connected bus.

The second aspect of the invention could also be constructed as an invalidity-monitoring system for monitoring invalid data, which causes a computer to execute an invalid operation, and comprising: a data-acquisition mechanism that acquires input/output data that is input or output over a network that is connected to the computer, or over an externally connected bus that connects the computer with an external device; an ID-information-identification means that identifies ID information from the input/output data for identifying a user; a user-information-storer that stores attribute information for all users having authorization to use the computer; an attribute-information acquisition mechanism that acquires at least part of the attribute data corresponding to the ID information from the user-information-storer; a determination-rule-storer for storing rules for determining whether the input/output data is invalid data; an invalid-data-determination mechanism that references the determination-rule-storer, and determining whether the input/output data is invalid data; and a notification mechanism that notifies the terminal being operated by the user or administrator that the operation being executed by the input/output data is an invalid operation when it is determined by the invalid-data-determination mechanism that the input/output data is invalid data; and where the determination-rule-storer stores determination rules that correspond to user attributes; and the invalid-data-determination mechanism references the determination rules that correspond to attribute information acquired by the attribute-information-acquisition mechanism to determine whether the input/output data is invalid.

According to various embodiments of the invention, when monitoring invalid data which caused a computer to execute an invalid operation, it is possible to not only monitor data that is input or output over a network, but also monitor data that is input or output between the computer and an external device, making it possible to prevent the leakage of information due to invalid output of data by an unauthorized person or by a person posing as an authorized person.

Also, by using user attribute information that is registered in advance for one rule item, it is possible to set various rules for determining invalidity. Moreover, by using attribute information to determine whether there is authorization to use the computer before applying rules, it is possible to make the process of determining invalidity more efficient. Furthermore, by recording an operation log for each user as user profiles, it becomes possible to identify patterns of unusual operation that cannot be determined using rules, and thus it is possible to determine whether there is a possibility that a third party is posing as an authorized user, and to determine operation, which even though it is in the range of being authorized, could be an invalid operation that is not normally executed.

### BRIEF EXPLANATION OF THE DRAWINGS

The invention is explained below with reference to various preferred embodiments, these embodiments being illustrated in the following drawings.

FIG. 1 is a pictorial schematic diagram showing an example of the invalidity-monitoring system according to an embodiment of the present invention that is used for monitoring a network;

FIG. 2 is a block diagram showing an example of the invalidity-monitoring system of the present invention that is used for monitoring the connection with external devices;

FIG. 3 is a block diagram showing the installation position of the invalidity-monitoring system of an embodiment of the present invention;

FIG. 4 is a block diagram showing a first configuration of the invalidity-monitoring system of an embodiment of the present invention;

FIG. 5 is a block diagram showing a second configuration of the invalidity-monitoring system of an embodiment of the present invention;

FIG. 6 is a table showing an example of the user-data-storage unit of the invalidity-monitoring system of an embodiment of the present invention;

FIG. 7 is a table showing an example of the invalidity-rule-storage unit of the invalidity-monitoring system of an embodiment of the present invention; and

FIGS. 8A & B is a flowchart showing the flow of the invalidity-monitoring program of an embodiment of the present invention.

### DESCRIPTION OF THE PREFERRED EMBODIMENTS

The preferred embodiments of the invention will be explained in detail below with reference to the drawings. The embodiments explained below are only examples, and the invention is not limited to these embodiments.

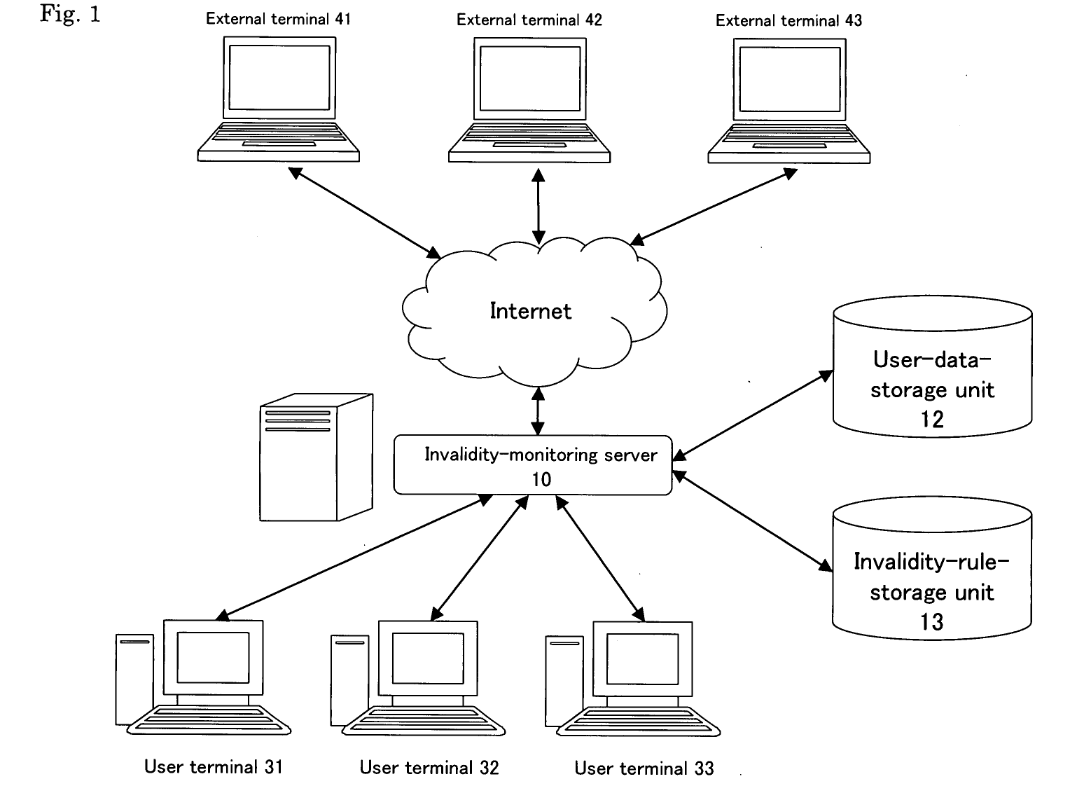

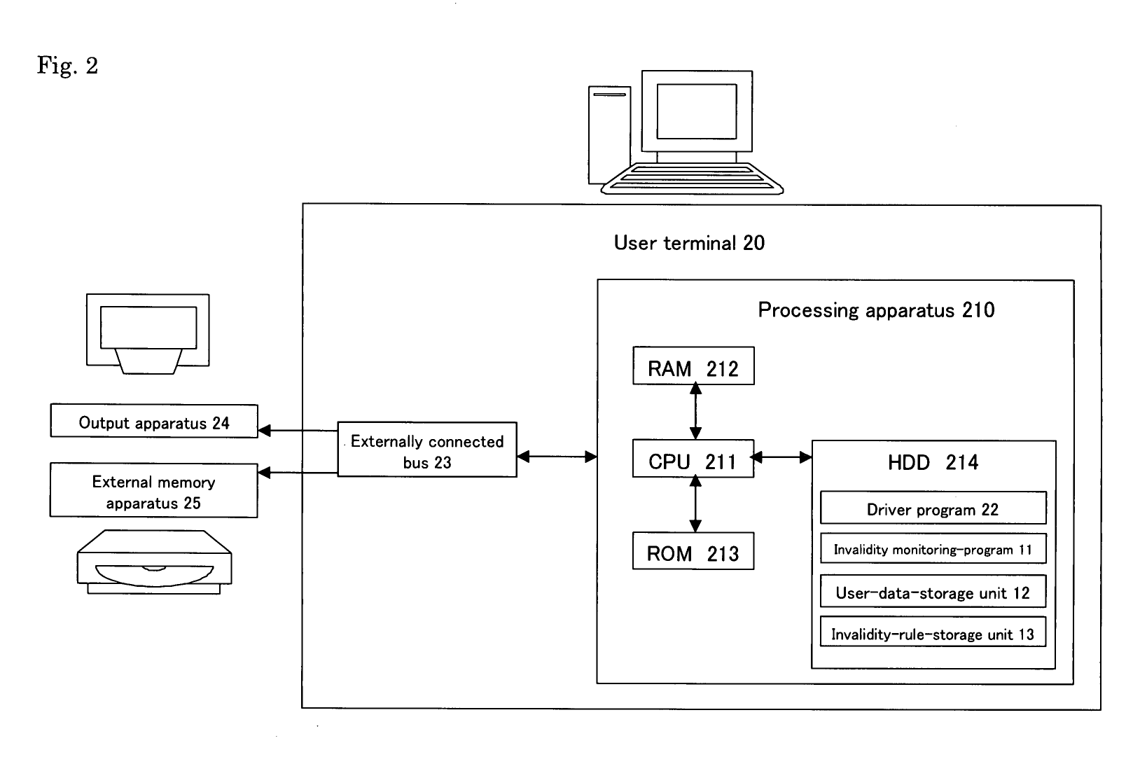

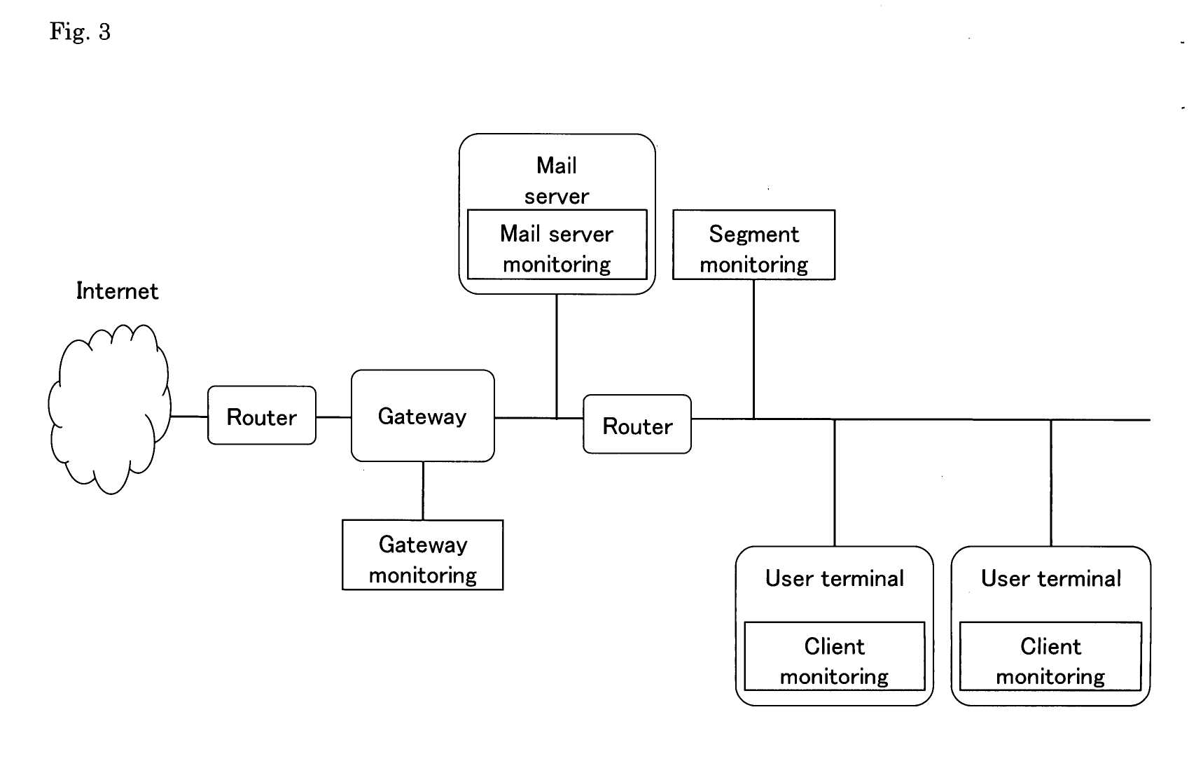

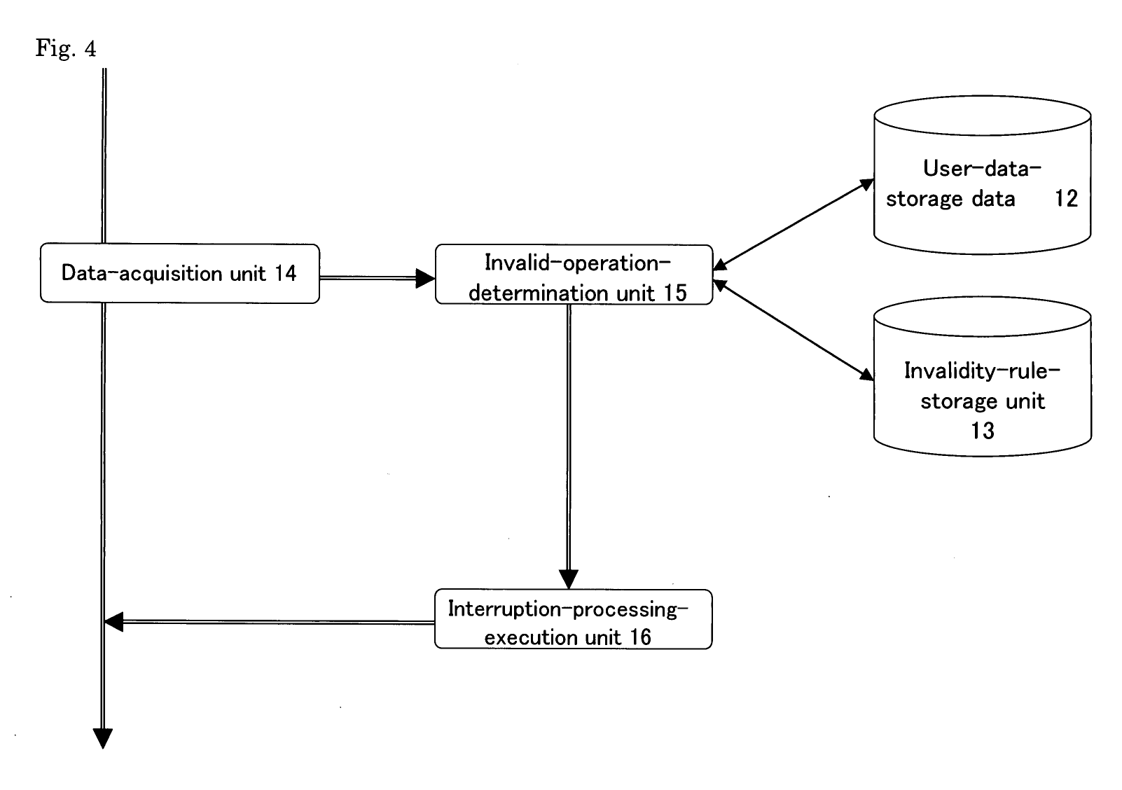

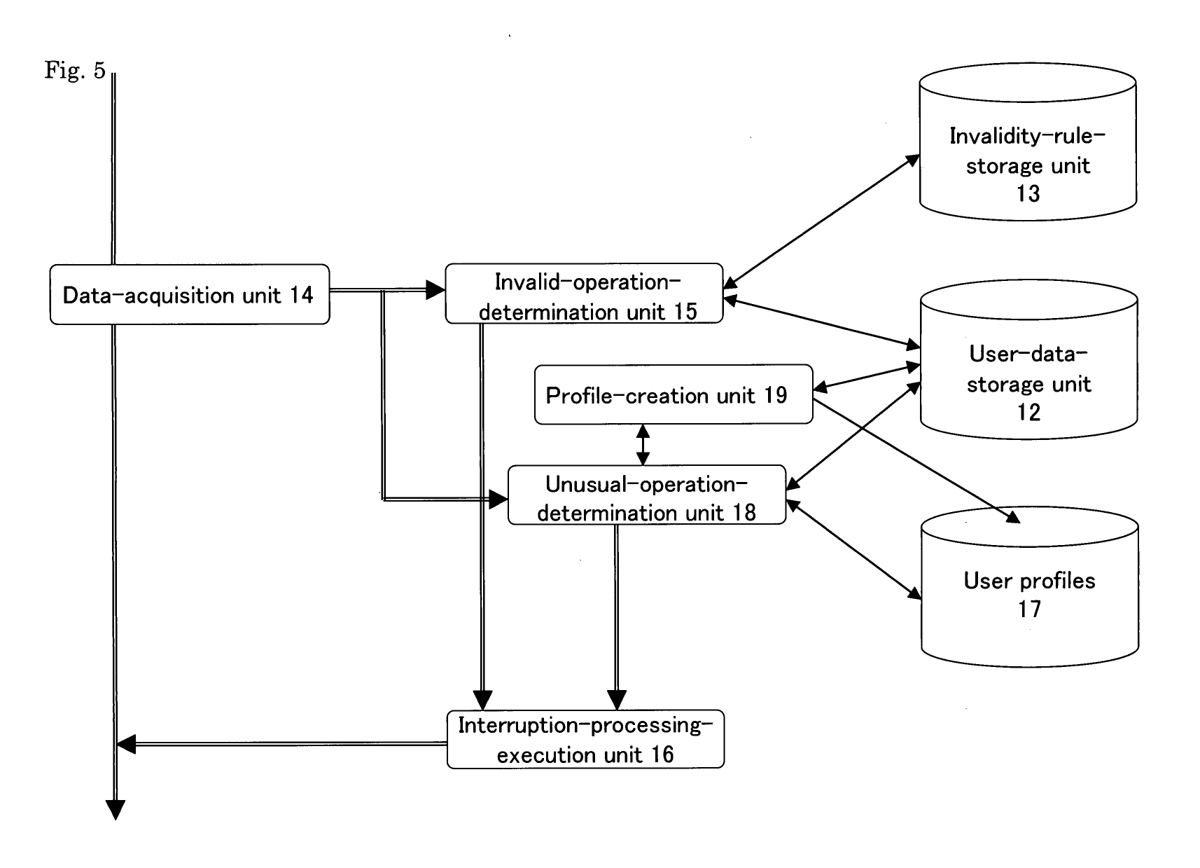

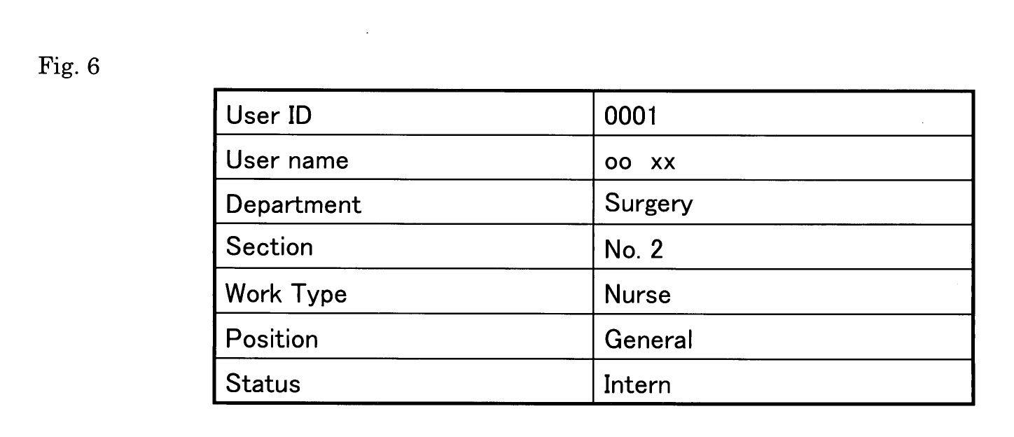

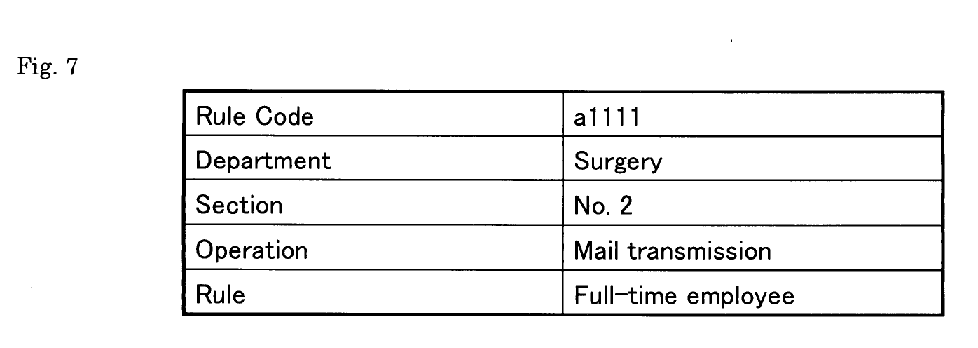

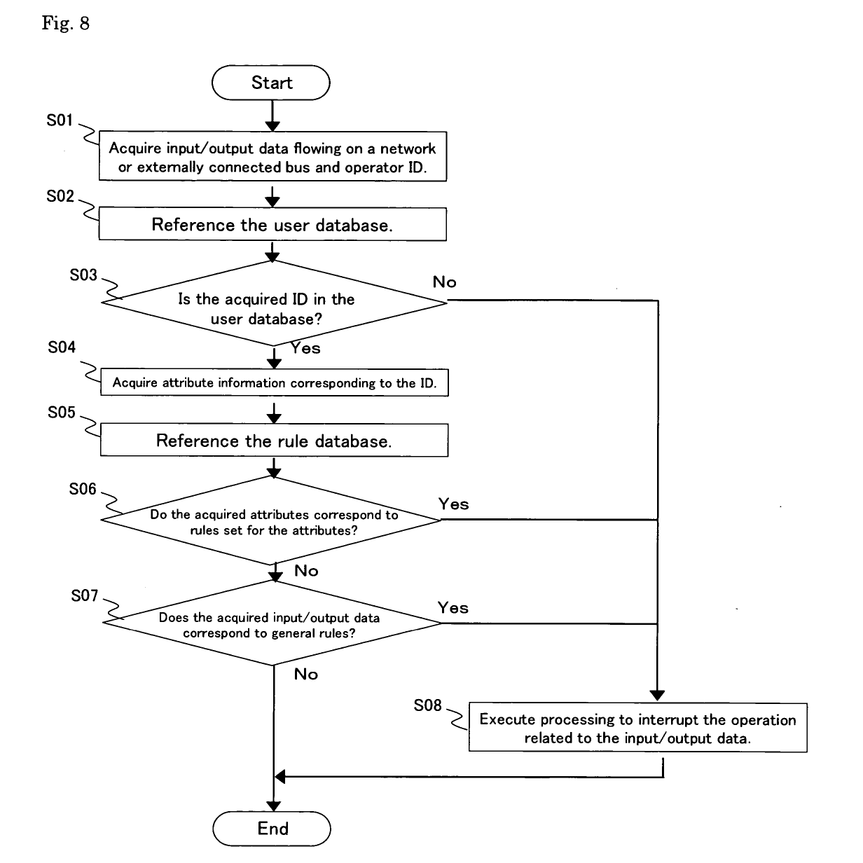

FIG. 1 and FIG. 2 are drawings showing examples of using the invalidity-monitoring system to monitor a network and to monitor the connection with external devices. FIG. 3 is a drawing showing the installation position of the invalidity-monitoring system. FIG. 4 and FIG. 5 are block diagrams showing a first and second configuration of the invalidity-monitoring system. FIG. 6 is a drawing showing an example of the user-data-storage unit of the invalidity-monitoring system. FIG. 7 is a drawing showing an example of the invalidity-rule-storage unit of the invalidity-monitoring system. FIG. 8 is a flowchart showing the flow of the invalidity-monitoring program.

The invalidity-monitoring system is capable of not only monitoring various kinds of data that flow over a network, but is also capable of monitoring an externally connected bus for connecting to external devices including output apparatus such as a printer and the like, and external memory apparatus such as an external disk drive and the like. As shown in FIG. 3, the invalidity-monitoring system can be located in the gateway between an internal network, such as an in-office LAN, and the Internet, and can monitor a network, or can be located in a mail server, and can monitor sending and receiving of e-mail that is exchanged over a network. Also, it can be used for monitoring segments in an internal network, or can also be used for monitoring connections between individual user terminals and network, or connections between individual user terminals and external devices.

FIG. 1 is an example of the case when the system is used for monitoring a network, and the invalidity-monitoring system is constructed so that it comprises: an invalidity-monitoring server 10, a user-data-storage unit 12 and an invalidity-rule-storage unit 13. The invalidity-monitoring server 10 can be such that it is located in the gateway between an internal network and the Internet, and monitors the leakage of invalid data from the entire internal network, or can be such that it is located in an internal network, and monitors the leakage of invalid data in segments of the internal network.

The invalidity-monitoring server 10 acquires all of the input/output data that flows along the network and acquires information from the user-data-storage unit 12 related to the attributes of the user who is performing input/output of data. In addition to general rules for determining invalid data, rules for determining invalidity according to the attributes of a user are stored in the invalidity-rule-storage unit 13; and the invalidity-monitoring server 10 references the invalidity-rule-storage unit 13 for referencing the general rules for determining invalidity related to the input/output data, and references the rules corresponding to the attributes acquired from the user-data-storage unit 12 in order to determine whether or not the input/output data is invalid. For input/output data that was determined to be invalid, the invalidity-monitoring server 10 executes processing to block the session for which input/output is being performed.

FIG. 2 is an example showing the case when the system is used for monitoring an externally connected bus, where the invalidity-monitoring system of the invention is constructed so that it comprises: an invalidity-monitoring program 11 that is stored in, e.g., the hard disk drive (HDD) 214 of a processing apparatus 210, a user-data-storage unit 12 and an invalidity-rule-storage unit 13; and where the program and stored data are read from the HDD 214 when monitoring is executed, and computation processing is performed by the processing apparatus 210. In the processing apparatus 210, a CPU 211 activates various fundamental programs that are stored in, e.g., read-only memory (ROM) 213 for performing hardware control such as input control or output control in order to execute monitoring by the invalidity-monitoring program 11 that is stored in the HDD 214, and using random-access memory (RAM) 212 that functions as a work area for the invalidity-monitoring program 11, performs computation processing. In the computation process of the invalidity-monitoring program 11, necessary data are read from the user-data-storage unit 12 and invalidity-rule-storage unit 13 in the HDD 214, and used. In the processing apparatus, it is also possible to use another memory medium, such as a flash memory that is capable of storing a program, instead of the HDD 214 that stores the program.

When the driver program 22 is read by the processing apparatus 210 and instruction data for a print out or for writing to an external disc is sent to an externally connected bus 23, the invalidity-monitoring program acquires the instruction data flowing on the externally connected bus 23 and acquires information from the user-data-storage unit 12 about the attributes of the user performing operation related to that instruction data. In addition to general rules for determining invalid data, rules for determining invalidity according to user attributes are stored in the invalidity-rule-storage unit 13, and together with executing processing for determining whether or not the instruction data corresponds to general determination rules that are stored in the invalidity-rule-storage unit 13, the invalidity-monitoring program 11 executes processing for determining whether the instruction data corresponds to attribute rules acquired from the user-data-storage unit 12.

For instruction data that is determined to be invalid, the invalidity-monitoring program 11 executes processing to stop the processing executed by the driver program 22, for example, executes a process such as stopping a print out, or stopping communication with a computer that is directly connected to the externally connected bus 23.

The method by the invalidity-monitoring server 10 shown in FIG. 1, and the invalidity-monitoring program 11 shown in FIG. 2 for determining invalidity will be explained in further detail using FIG. 4 and FIG. 5. FIG. 4 shows a determination method in which rules according to user attributes are added to general rules for determining invalidity, and FIG. 5 shows a system in which not only is determination performed on a rule basis, but in which operating patterns are determined from profiles of each user, and invalidity is determined when there is unusual operation.

Determination of invalidity as shown in FIG. 4 is performed in the order of first having a data-acquisition unit 14 acquire data which will be the target of a validity determination, then having an invalid-operation-determination unit 15 determine whether there is invalid operation on a rule basis, and finally, having an interruption-processing-execution unit 16 stop processing in question. These units do not have to be physically separated from each other, but can each be stored in the HDD 214 as a part of the invalidity-monitoring program 11 that executes them, and can be read in order by the CPU 211 that executes computation processing with RAM 212 functioning as a work area.

The data-acquisition unit 14 acquires data that is flowing on the network or on an externally connected bus. The acquired data includes ID data for identifying the user executing the operation related to the data. The ID data is specified by the login ID or the like when a user logs into a computer.

The invalid-operation-determination unit 15 acquires user attribute information from the user-data-storage unit 12 that corresponds to the user ID data that was acquired by the data-acquisition unit 14. FIG. 6 is a table providing an example of user attribute information that is stored in the user-data-storage unit 12, where records for each user store a user ID, and attribute information such as department, work type, and the like.

Next, the invalid-operation-determination unit 15 references the invalidity-rule-storage unit 13 and determines whether or not the data acquired by the data-acquisition unit 14 corresponds to a rule determining that it is invalid data. General rules for determining invalidity regardless of user attributes, and attribute rules that determine unauthorized events according to user attributes are stored in the invalidity-rule-storage unit 13. The former are rules that are generally used for determining invalidity based on a keyword, URL, IP address, MAC address or the like. The latter are rules such as operation authorization that is set for a specific operation according to an attribute such as department or work position.

FIG. 7 is a table showing an example of determination rules that are set according to user attributes stored in the invalidity-rule-storage unit 13. Attributes to be targeted and rules to be applied are stored in records that are set up in rule units, and in this example, only full-time employees are given authorization to send e-mail. For example, when a nurse intern tries to send e-mail in the example shown in FIG. 6, it is determined that the intern is not authorized to send e-mail, and the e-mail sending process is stopped.

When the invalid-operation-determination unit 15 determines that the operation related to the acquired data is an invalid operation in this way, the interruption-processing-execution unit 16 executes a process for stopping the process executed by that operation. In other words, a blocking process is executed for the data that is input or output over the network for the session for which input/output was performed, or processing such as stopping a print out or stopping writing to an external disc is executed for the execution-processing data that is sent to an externally connected bus.

In the invalid-operation-determination unit 15, when there is no data corresponding to the user ID when acquiring user attribute information from the user-data-storage unit 12, or when the user ID is invalid due to the retirement of the user or the like, access is taken to be by an unauthorized party, and the operation is determined to be invalid without performing a determination by the invalidity-rule-storage unit 13, and the operation can be interrupted by the interruption-processing-execution unit 16. By determining that access is from an unauthorized party before performing determination on a rule basis, the processing load of the system is reduced, and it becomes possible to perform determination and execute the interrupt process quickly.

In the invalidity determination shown in FIG. 5, the data-acquisition unit 14 acquires data for the invalidity determination, the invalid-operation-determination unit 15 determines whether there is invalid operation on a rule basis, an unusual-operation-determination unit 18 determines whether there is invalid operation from operation patterns for each of the user and not on a rule basis, and the interruption-processing-execution unit 16 stops the process in question. As in the case shown in FIG. 4, these units do not need to be physically separated from each other, but can be stored in the HDD 214 as parts of the invalidity-monitoring program 11 that executes them, and can be read in order by the CPU 211 that executes computation processing with RAM 212 functioning as a work area.

Also in FIG. 5, the processing of having the data-acquisition unit 14 acquire target data for determination, having the invalid-operation-determination unit 15 determine on a rule basis whether there is invalid operation, and having the interruption-processing-execution unit 16 stop the process in question, is the same as the processing shown in FIG. 4. This configuration is characterized in that a profile-creation unit 19 creates profiles for each user, and the unusual-operation-determination unit 18 determines whether there is invalid operation from the operating patterns of each user.

For the data that was acquired by the data-acquisition unit 14, invalidity determination is performed on a rule basis by the invalid-operation-determination unit 15, and is performed according to the operation patterns of each user by the unusual-operation-determination unit 18. Past operation patterns for each user are registered in the user profiles 17, and the unusual-operation-determination unit 18 compares the operation related to the acquired data with the operation pattern for that user that is registered in the user profiles 17, and when it determines that the operation is invalid, the interruption-processing-execution unit 16 interrupts the process.

For example, when a user performs an operation at certain times of the day when the user does not usually operate, or when the user executes a certain type of operation numerous times that the user does not normally execute, it is determined that there is a possibility that the user executes an invalid operation, or that a third party is posing as an authorized user using someone else's ID, and the process is interrupted.

The operation patterns that are registered in the user profiles 17 can be created from data that is used in the determination by the unusual-operation-determination unit 18, and user attribute information from the user-data-storage unit 12. It is also possible to use a log of data acquired by the data-acquisition unit 14. The profiles can be updated by an online process that is executed each time new data is acquired, or can be updated by periodic batch processing.

There is a “knowledge engine” in the unusual-operation-determination unit 18 for comparing operation with user profiles 17 and determining whether the operation is unusual operation. The knowledge engine comprises an artificial intelligence function that is capable of discriminating between normal operation and unusual operation, where the artificial intelligence can be configured using a Bayesian network, or can be configured using a neural network.

In the embodiments explained above, processing is executed to block a session when operation is determined to be invalid operation, and in the case of execution-processing data over an externally connected bus, processing is executed such as stopping a print out, or stopping writing to an external disc; however, construction could also be such that when operation is determined to be invalid operation, a warning is sent to the user executing that operation or to the computer or network administrator.

The basic flow of the invalidity-monitoring program of the invention will be explained using the flowchart shown in FIGS. 8A & B. First, the program acquires input/output data that is flowing on the network or externally connected bus, and the ID of the operator that executed the operation related to that input/output data S01. For the acquired ID, the program references the user database that stores user attribute information S02, and when that ID does not exist in the user database S03, determines that operation is by an unauthorized party, and executes processing to stop the operation related to that input/output data S08.

When the ID exists in the user database S03, the program acquires attribute information related to that ID from the user database S04. Next, the program references the rule database S05, and determines whether the acquired attributes correspond to the rules set for the attributes S06. When the attributes correspond, the program determines that operation is by a party that is unauthorized for that operation, and executes processing to stop the operation related to that input/output data S08. When the attributes do not correspond, the program determines whether the acquired input/output data corresponds to general rules S07. When the data corresponds, the program determines that the operation is an invalid operation, and executes processing to stop the operation related to that input/output data S08. When the data does not correspond, the program determines that the operation is proper, and the operation related to that input/output data is executed as is.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential”or “critical”. Numerous modifications and adaptations will be readily apparent to those skilled in this art without departing from the spirit and scope of the present invention.

1-14. (canceled)

15. An invalidity-monitoring program for monitoring invalid data which causes a computer to execute an invalid operation, comprising:
software that acquires input/output data that is input or output over a network that is connected to said computer, or over an externally connected bus that connects said computer with an external device;
software that identifies ID information from said input/output data for identifying a user;
software that acquires at least part of attribute data corresponding to said ID information from a user-information-storage unit that stores attribute information for all users having authorization to use said computer;
software that references a determination-rule-storage unit that stores rules for determining whether said input/output data is invalid data, and determines whether said input/output data is invalid data; and
software that stops execution by said input/output data when it is determined in said invalid-data-determination that said input/output data is invalid data;
wherein
said determination-rule-storage unit stores determination rules that correspond to user attributes; and
software that references, in said determining of whether said input/output data is invalid data, said determination rules that correspond to attribute information acquired in the acquisition of attribute information determines whether said input/output data is invalid.

16. The invalidity-monitoring program of claim 15, further comprising:
software that references said user-information-storage unit and determines whether the user corresponding to said ID information has authorization to use said computer; and
software that stops operation by said input/output data when it is determined in the determination of authorization that there is no authorization to use said computer;
wherein
said software that determines authorization performs this before it is determined whether said input/output data is invalid data, and when it is determined in the determining authorization that there is no authorization to use said computer, said program causes said computer to not execute at least one of the following: acquiring attribute information and said determination of whether said input/output data is invalid data.

17. The invalidity-monitoring program of claim 15, further comprising:
software that references a profile-storage unit that stores log data related to said input/output data as profiles for each user, and compares input/output data that was acquired in said data-acquisition with a normal operation trend of said user to determine whether operation is unusual; and
software that stops an operation executed by said input/output data in said stopping operation executed by said input/output data also when it is determined in said determining whether operation is unusual that that operation is unusual.

18. The invalidity-monitoring program of claim 15, further comprising software that executes a process of interrupting a session in said stopping of the operation executed by said input/output data when said input/output data is acquired from a network in said acquisition of input/output data.

19. The invalidity-monitoring program of claim 15, further comprising software that stops the process of executing a driver in the stopping of the operation executed by said input/output data when said input/output data is acquired from an externally connected bus in said acquisition of input/output data.

20. An invalidity-monitoring program for monitoring invalid data which causes a computer to execute an invalid operation, comprising:
software that acquires input/output data that is input or output over a network that is connected to said computer, or over an externally connected bus that connects said computer with an external device;
software that identifies ID information from said input/output data for identifying a user;
software that acquires at least part of attribute data corresponding to said ID information from a user-information-storage unit that stores attribute information for all users having authorization to use said computer;
software that references a determination-rule-storage unit that stores rules for determining whether said input/output data is invalid data, and determining whether said input/output data is invalid data; and
software that notifies a terminal being operated by said user or administrator that an operation being executed by said input/output data is an invalid operation when it is determined in said determining whether said input/output data is invalid that said input/output data is invalid data;
wherein
said determination-rule-storage unit stores determination rules that correspond to user attributes; and
software that references, in said step of determining whether said input/output data is invalid data, said determination rules that correspond to attribute information acquired in said step of acquiring attribute information to determine whether said input/output data is invalid data.

21. An invalidity-monitoring method for monitoring invalid data, which causes a computer to execute an invalid operation, comprising:
acquiring, by said computer, input/output data that is input or output over a network that is connected to said computer, or over an externally connected bus that connects said computer with an external device;
identifying, by said computer, ID information from said input/output data for identifying a user;
acquiring, by said computer, at least part of attribute data corresponding to said ID information from a user-information-storage unit that stores attribute information for all users having authorization to use said computer;
referencing, by said computer, a determination-rule-storage unit that stores rules for determining whether said input/output data is invalid data;
determining whether said input/output data is invalid data based on said rules; and
stopping, by said computer, execution by said input/output data when it is determined in said invalid-data-determination step that said input/output data is invalid data;
wherein
said determination-rule-storage unit stores determination rules that correspond to user attributes; and
in said step of determining whether said input/output data is invalid data, referencing said determination rules that correspond to attribute information acquired in said step of acquiring attribute information to determine whether said input/output data is invalid.

22. An invalidity-monitoring method for monitoring invalid data, which causes a computer to execute an invalid operation, comprising:
acquiring, by said computer, input/output data that is input or output over a network that is connected to said computer, or over an externally connected bus that connects said computer with an external device;
identifying, by said computer, ID information from said input/output data for identifying a user;
acquiring, by said computer, at least part of attribute data corresponding to said ID information from a user-information-storage unit that stores attribute information for all users having authorization to use said computer;
referencing, by said computer, a determination-rule-storage unit that stores rules for determining whether said input/output data is invalid data;
determining whether said input/output data is invalid data; and
notifying, by said computer, a terminal being operated by said user or administrator that an operation being executed by said input/output data is an invalid operation when it is determined in said step of determining whether said input/output data is invalid that said input/output data is invalid data;
wherein
said determination-rule-storage unit stores determination rules that correspond to user attributes; and
in said step of determining whether said input/output data is invalid data, referencing said determination rules that correspond to attribute information acquired in said step of acquiring attribute information to determine whether said input/output data is invalid.

23. An invalidity-monitoring system for monitoring invalid data, which causes a computer to execute an invalid operation, the system comprising:
a computer having a connection to a network or to an external device;
a data-acquisition mechanism for acquiring input/output data that is input or output over the network that is connected to said computer, or over an externally connected bus that connects said computer with the external device;
an ID-information-identifier for identifying ID information from said input/output data for identifying a user;
a user-information-store for storing attribute information for all users having authorization to use said computer;
an attribute-information acquisition mechanism for acquiring at least part of the attribute data corresponding to said ID information from said user-information-store;
a determination-rule-store for storing rules for determining whether said input/output data is invalid data;
an invalid-data-determination mechanism for referencing said determination-rule-store, and determining whether said input/output data is invalid data; and
a stoppage mechanism for stopping execution by said input/output data when it is determined by said invalid-data-determination mechanism that said input/output data is invalid data;
wherein
said determination-rule-store stores determination rules that correspond to user attributes; and
said invalid-data-determination mechanism references said determination rules that correspond to attribute information acquired by said attribute-information-acquisition mechanism to determine whether said input/output data is invalid.

24. The invalidity-monitoring system of claim 23 further comprising:
a use-authorization-determination mechanism for referencing said user-information-store and determining whether the user corresponding to said ID information has authorization to use said computer;
wherein
said stoppage mechanism also stops operation executed by said input/output data when it is determined by said use-authorization-determination mechanism that there is no authorization to use said computer;
said use-authorization-determination mechanism is activated before said invalid-data-determination mechanism; and
when it is determined by said use-authorization-determination mechanism that there is no authorization to use said computer, at least one of the following; said attribute-information-acquisition mechanism or said invalid-data-determination mechanism does not execute.

25. The invalidity-monitoring system of claim 23 further comprising:
a profile-store for storing log data related to said input/output data as profiles for each user; and
an unusual-operation-determination mechanism for referencing said profile-store and comparing input/output data that was acquired by said data-acquisition mechanism with the normal operation trend of said user to determine whether operation is unusual;
wherein
said stoppage mechanism also stops an operation executed by said input/output data when it is determined by said unusual-operation-determination mechanism that operation is unusual.

26. The invalidity-monitoring system of claim 23, wherein said stoppage mechanism executes a process of interrupting a session when said data-acquisition mechanism acquired said input/output data from a network.

27. The invalidity-monitoring system of claim 23, wherein said stoppage mechanism stops a process of executing a driver when said data-acquisition mechanism acquired said input/output data from an externally connected bus.

28. An invalidity-monitoring system for monitoring invalid data, which causes a computer to execute an invalid operation, the system comprising:
a computer having a connection to a network or to an external device;
a data-acquisition mechanism for acquiring input/output data that is input or output over the network that is connected to said computer, or over an externally connected bus that connects said computer with the external device;
an ID-information-identification mechanism for identifying ID information from said input/output data for identifying a user;
a user-information-store for storing attribute information for all users having authorization to use said computer;
an attribute-information acquisition mechanism for acquiring at least part of the attribute data corresponding to said ID information from said user-information-store;
a determination-rule-storage mechanism for storing rules for determining whether said input/output data is invalid data;
an invalid-data-determination mechanism for referencing said determination-rule-store, and determining whether said input/output data is invalid data; and
a notification mechanism for notifying the terminal being operated by said user or administrator that an operation being executed by said
input/output data is an invalid operation when it is determined by said invalid-data-determination means that said input/output data is invalid data.
wherein
said determination-rule-storage mechanism stores determination rules that correspond to user attributes; and
said invalid-data-determination mechanism references said determination rules that correspond to attribute information acquired by said attribute-information-acquisition mechanism to determine whether said input/output data is invalid.
